(19) United States
(12) Patent Application Publication
(10) Pub. No.: US 2026/0058867 A1
(43) Pub. Date: Feb. 26, 2026

(54) System and method for managing network conditions in a multi-tenant environment

(71) Applicant: DISH Wireless L.L.C., Englewood, CO (US)

(72) Inventors: Kazi Bashir, Lewisville, TX (US); Rajesh Chilka, Littleton, CO (US); Mehdi Alasti, Arlington, VA (US); Siddhartha Chenumolu, Ashburn, VA (US)

(21) Appl. No.: 18/809,441

(22) Filed: Aug. 20, 2024

(51) Int. Cl. H04L 41/0686; H04L 43/065; H04L 67/02

(52) U.S. Cl. CPC H04L 41/0686; H04L 43/065; H04L 67/02

(57) ABSTRACT

A system for mitigating network error conditions in a multi-tenant environment is disclosed. The system transmits a policy request message to a server network function. The policy request message may include a tenant identifier (ID) and a network slice ID associated with a client device from which a network resource request is received. In response, the system receives a hypertext transfer protocol version 2 (HTTP/2) status code from the server network function. The system determines a type of the HTTP/2 status code, where the type of the HTTP2 status code indicates a type of condition. The system executes mitigation actions associated with the HTTP/2 status code. The mitigation actions are customized based on the tenant ID, slice ID, or the type of the HTTP2 status error code. The system determines and outputs a result of the one or more mitigation actions.

### TECHNICAL FIELD

The present disclosure relates generally to wireless communication, and more specifically to system and method for managing network conditions in a multi-tenant environment.

### BACKGROUND

Client devices may request network resources from a client network function. In response, the client network function (referred to as a consumer in 3^{rd} generation partnership project (3GPP)) may transmit a network policy request message to a server network function (referred to as a producer in 3GPP) in a control plane. The server network function may issue and transmit a hypertext transfer protocol version 2 (HTTP/2) status code to the client network function.

### SUMMARY

The system described in the present disclosure provides several practical applications and technical advantages that overcome the current technical problems in wireless communication technology as described herein. The following disclosure is particularly integrated into a practical application of reducing network congestion, improving network communication connectivity and reliability, and network error handling techniques, specifically, in situations where a hypertext transfer protocol version 2 (HTTP/2) status error code is detected.

HTTP/2 status codes are categorized into several types, where each type may represent a different type of response from a server to a client. The HTTP/2 status codes include 1xx (informational responses—the request was received, continuing process), 2xx (successful—the request was successfully received, understood, and accepted), 3xx (redirection—further action needs to be taken in order to complete the request), 4xx (client error—the request contains bad syntax or cannot be fulfilled), and 5xx (server error—the server failed to fulfill an apparently valid request). Among the HTTP/2 status codes, in some cases, a server's response may be HTTP/2 4xx or 5xx error. For instance, different actions may be applied based on tenant's policy on HTTP/2 3xx redirection code. In some examples, an HTTP/2 status error code may be issued by a server network function (e.g., policy control function (PCF)) in cases where there is a client-side error (e.g., request with bad syntax, unauthorized access, resource not found), a server-side error (e.g., internal server error, service unavailable), a network-side error (e.g., network congestion, connectivity failure, etc.), a requirement for further action (e.g., redirection needed), among other issues.

The 5th generation (5G) control plane is based on service-based architecture (SBA) and service-based interface (SBI). The 5G SBA relies on a standardized set of RESTful application programming interfaces (APIs) combined with web-based technologies including transmission control protocol (TCP), transport layer security (TLS), HTTP/2, and JavaScript object notation (JSON) protocol suit for communication between the 5G network functions (NFs). The HTTP has standard HTTP response status codes from server to client, including 1xx (informational responses—the request was received, continuing process), 2xx (successful—the request was successfully received, understood, and accepted), 3xx (redirection—further action needs to be taken in order to complete the request), 4xx (client error—the request contains bad syntax or cannot be fulfilled), and 5xx (server error—the server failed to fulfill an apparently valid request). The xx in 1xx, 2xx, 3xx, 4xx, and 5xx may be any number as defined in the HTTP/2 status code standard. Each HTTP/2 status code indicates a specific message, including a successful processing, an error message, or the request is successfully processed.

An HTTP/2 status code may be issued by the server network function in response to a policy request from a client network function (e.g., if an HTTP/2 status error code is issued by the server network function, the error code may cause delayed network responses, network congestion, and disruption in network communication among client devices and the network, among multiple client devices, and among a client device and the client network function. If the HTTP/2 status code, such as status error code is not addressed in a timely manner, it will lead to an increased network load at other parts of the network, such as downstream devices as they attempt to handle retry requests.

Furthermore, an HTTP/2 status code may be with respect to communication with a particular network slice or tenant in a multi-tenant environment, where the particular network slice may have a higher priority than other network slices. Thus, if the HTTP/2 status error code is detected in a situation where a high-priority network slice is involved, addressing and mitigating the HTTP/2 status error code may be time sensitive. Additionally, in some cases, an action in response to an HTTP/2 status code, e.g., an error code, may depend on policies assigned to each tenant by a network operator. The policies may be based on service level agreement (SLA) among other network communication requirements for a given tenant. In one example, for a first tenant, when a syntax error is detected (often resulting in an HTTP/2 4xx status error code), the default action may be to reject the request. However, for a second tenant under a policy that allows for more flexibility compared to the first tenant, the server may instead grant limited access, rather than rejecting the request.

The current telecommunication systems fail to provide a solution to these and other technical problems in the realm of network communication. The disclosed system is configured to provide a solution to these and other technical problems in the network communication. In some embodiments, the disclosed system is configured to implement customized actions such as mitigation actions that are tailored per each combination of network slice identifier (ID) (optional), tenant ID, and HTTP/2 status code (whether error or non-error code). In implementations where the slice ID 152a is mapped to the tenant ID 154, using the slice ID 152a in the combination may be optional. For example, the disclosed system may be configured to execute a first mitigation action if a first combination of slice ID (optional), tenant ID, and HTTP/2 status code is detected, and execute a second mitigation action if a second combination of slice ID, tenant ID, and HTTP/2 status code is detected.

In this manner, the disclosed system is configured to determine a dynamic and customized mitigation action for a given network slice, tenant, and HTTP/2 status code, such as status error code. In this process, the disclosed system may adjust network responses based on the specific type of the HTTP/2 status code (e.g., error code) and the specific network communication and reliability requirements of the involved network slice and tenant. Additionally, the disclosed system may take the priority level of the slice into account when determining the mitigation action to be executed. For example, a mitigation action for a high-bandwidth streaming service in a first slice may differ from a low-bandwidth service in a second slice, even if they encounter the same HTTP/2 status code. The disclosed system may prioritize mitigation actions for slices that have higher priority levels (e.g., more than a threshold level) compared to other network slices. Therefore, the disclosed system is configured to improve network responses by reducing response latency and improving quality of service (OoS) of the responses, reduce network congestion, and improve network communication reliability by providing network slice-specific mitigation actions to various HTTP/2 status codes, such as status error codes. This, in turn, improves the network communication reliability techniques.

In some embodiments, a system for mitigating network error conditions in a multi-tenant environment comprises a memory operably coupled with a processor. The memory is configured to store one or more mitigation actions associated with a hypertext transfer protocol 2 (HTTP2) status codes, such as status error code. The processor is configured to transmit a policy request message to a server network function. The policy request message comprises at least a tenant identifier (ID). The policy request message indicates to provide an access management policy for a client device associated with the tenant ID. The processor is further configured to receive, from the server network function, the HTTP2 status code, such as status error code, wherein the HTTP2 status code is in response to a specific network request originated from the client device. The processor is further configured to determine a type of the HTTP2 status code, wherein the type of the HTTP2 status code indicates whether the HTTP2 status code is related to a client-side error, a server-side error, or a network-side error. The processor is further configured to execute one or more mitigation actions associated with the HTTP2 status code, in response to determining the type of the HTTP2 status code. The one or more mitigation actions are customized based at least in part upon at least one of the tenant ID, or the type of the HTTP2 status code. The processor is further configured to determine a result of the one or more mitigation actions, wherein the result is represented by a network communication in response to the executed one or more mitigation actions.

Certain embodiments of this disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an embodiment of a system for managing network conditions in a multi-tenant environment;

FIG. 2 illustrates an example flow chart of a method for managing network conditions in a multi-tenant environment; and

FIG. 3 illustrates an example embodiment of a server network function from the system of FIG. 1.

### DETAILED DESCRIPTION

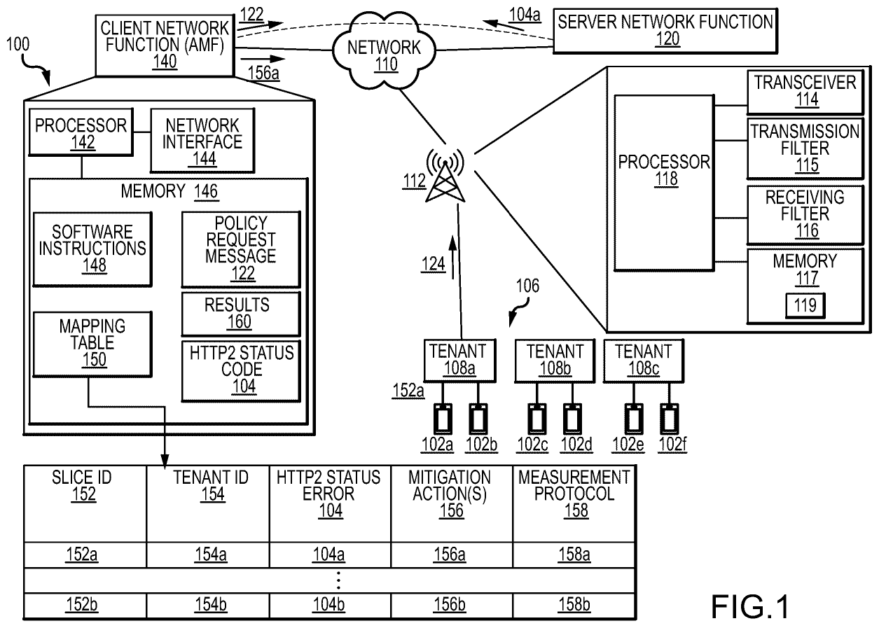

As described above, previous technologies fail to provide efficient and reliable solutions for managing network responses to conditions such as errors in a multi-tenant environment. Embodiments of the present disclosure and its advantages may be understood by referring to FIGS. 1 through 3. FIGS. 1 through 3 are used to describe systems and methods for managing network responses to non-error conditions and error conditions in a multi-tenant environment, according to certain embodiments of the present disclosure.

### System Overview

FIG. 1 illustrates an embodiment of a communication system 100 that is generally configured to address network reactions, such as error responses (specifically, hypertext transfer protocol version 2 (HTTP/2) status code) based on customized mitigation actions that are tailored for each network slice and tenant in a multi-tenant network environment. In some embodiments, the system 100 comprises a client network function 140 communicatively coupled with one or more server network functions 120, base stations 112, and client devices 102, via a network 110. The network 110 enables communication among the components of the system 100. The client network function 140 may be a server configured to manage and coordinate network and session communications of client devices 102 with the network 110. The server network function 120 may be a server configured to provide network policy rules which may govern the quality of service (QoS) among other network connectivity factors for the client devices 102 within the network 110. The base station 112 may facilitate the network communication of the client devices 102 with the network 110. In other embodiments, system 100 may not have all of the components listed and/or may have other elements instead of, or in addition to, those listed above.

In general, the system 100 is configured to improve network responses (e.g., response time), network connectivity quality and reliability, and error handling techniques in situations where an HTTP/2 status error code 104 is detected.

HTTP/2 status codes 104 are categorized into several types, where each type may represent a different type of response from a server to a client. The HTTP/2 status codes 104 include 1xx (informational responses—the request was received, continuing process), 2xx (successful—the request was successfully received, understood, and accepted), 3xx (redirection—further action needs to be taken in order to complete the request), 4xx (client error—the request contains bad syntax or cannot be fulfilled), and 5xx (server error—the server failed to fulfill an apparently valid request). Among the HTTP/2 status codes 104, in some cases, a server's response may be HTTP/2 4xx or 5xx error. For instance, different actions may be applied based on tenant's policy on HTTP/2 3xx redirection code. In some examples, an HTTP/2 status error code 104 may be issued by the server network function 120 in cases where there is a client-side error (e.g., request with bad syntax, unauthorized access, resource not found), a server-side error (e.g., internal server error, service unavailable), a network-side error (e.g., network congestion, connectivity failure, etc.), a requirement for further action (e.g., redirection needed), and among other issues.

In addition to handling standard HTTP/2 status error codes 104, the system 100 is further configured to implement customized actions based on tenant-specific policies and conditions in a multi-tenant environment. Thus, the system 100 is configured to address HTTP/2 status codes 104 and implement customized actions that extend beyond error codes. For example, the system 100 is configured to implement various operational scenarios tailored to each tenant's unique network requirements for any HTTP/2 status code 104—whether error or non-error code.

The 5^{th} generation (5G) control plane is based on service-based architecture (SBA) and service-based interface (SBI). The 5G SBA relies on a standardized set of restful application programming interfaces (APIs) combined with web-based technologies including transmission control protocol (TCP), transport layer security (TLS), hypertext transfer protocol version 2 (HTTP/2), and JavaScript object notation (JSON) protocol suit for communication between the 5G network functions (NFs). The HTTP has standard HTTP response status codes from server to client, including 1xx (informational responses—the request was received, continuing process), 2xx (successful—the request was successfully received, understood, and accepted), 3xx (redirection- further action needs to be taken in order to complete the request), 4xx (client error—the request contains bad syntax or cannot be fulfilled), and 5xx (server error—the server failed to fulfill an apparently valid request). The xx in 1xx, 2xx, 3xx, 4xx, and 5xx may be any number as defined in the HTTP/2 status code standard. Each HTTP/2 status code indicates a specific message, including a successful processing, an error message, or the request is successfully processed.

An HTTP/2 status code 104 may be issued by the server network function 120 in response to a client network function 140's request. If an HTTP/2 status error code 104 is issued by the server network function 120, the error code may cause delayed network responses, network congestion, and disruption in network communication among client devices 102 and the network 110, between client devices 102, and between a client device 102 and the client network function 140. If the HTTP/2 status code, such as status code 104 is not addressed in a timely manner, it may lead to an increased network load at other parts of the network, such as downstream devices as they attempt to handle retry requests.

Furthermore, an HTTP/2 status code 104 may be with respect to communication with a particular network slice 106 or tenant 108 in a multi-tenant environment, where the particular network slice 106 may have a higher priority than other network slices 106. Thus, if the HTTP/2 status status code such as error code 104 is detected in a situation where a high-priority network slice 106 is involved, addressing and mitigating the HTTP/2 status code such as error code may be time sensitive. Additionally, in some cases, an action in response to an HTTP/2 status code 104, e.g., an error code, may depend on policies assigned to each tenant by a network operator. The policies may be based on service level agreement (SLA) among other network communication requirements for a given tenant. In one example, for a first tenant, when a syntax error is detected (often resulting in an HTTP/2 4xx status error code), the default action may be to reject the request. However, for a second tenant under a policy that allows for more flexibility compared to the first tenant, the server network function 120 may instead grant limited access, rather than rejecting the request.

The current telecommunication systems fail to provide a solution to these and other technical problems in the realm of network communication. The system 100 is configured to provide a solution to these and other technical problems in the network communication. In some embodiments, the system 100 is configured to implement customized actions such as mitigation actions 156 that are tailored per each combination of network slice identifier (ID) 152, tenant ID 154, and HTTP/2 status code such as status error code 104. For example, the system 100 may be configured to execute a first mitigation action 156a if a first combination of slice ID 152a, tenant ID 154a, and HTTP/2 status code 104a is detected and execute a second mitigation action 156b if a second combination of slice ID 152b, tenant ID 154b, and HTTP/2 status code 104b is detected. While some implementations may map tenant ID 154 to slice ID 152, this may vary by implementation. Thus, in some embodiments, a combination of a tenant ID 154 and HTTP/2 status code 104 may be used to determine and execute tailored mitigation actions 156 for each tenant identified with the respective tenant ID 154.

In this manner, the system 100 is configured to determine a dynamic and customized mitigation action 156 for a given network slice, tenant, and HTTP/2 status code 104. In this process, the system 100 may adjust network responses based on the specific type of the HTTP/2 status code, such as status error code 104 and the specific network communication and reliability requirements of involved network slice 106 and tenant 108. Additionally, the system 100 may take the priority level of the slice 106 into account when determining the mitigation action 156 to be executed. For example, a mitigation action 156 for a high-bandwidth streaming service in a first slice 106 may differ from a low-bandwidth service in a second slice 106, even if they encounter the same HTTP/2 status code, such as status error code 104. The system 100 may prioritize mitigation actions 156 for slices 106 that have higher priority levels (e.g., more than a threshold level) compared to other network slices 106. Therefore, the system 100 is configured to improve network responses by reducing response latency and improving quality of service (OoS) of the responses, reduce network congestion, and improve network communication reliability by providing a network slice-specific mitigation actions 156 to various HTTP/2 status code, such as status error codes 104. This, in turn, improves the network communication reliability techniques.

### System Components

### Example Client Device

The client device 102 may generally be any network device that is configured to communicate data with the base station 112. The client device 102 may be operated by a user. Some examples of the client device 102 may include but are not limited to, user equipment's (UEs), computing devices, smartphones, tablets, notebook computers, mobile devices, sensors, vehicles, autonomous vehicles, machinery, appliances, smart speakers, digital assistants, security cameras, monitoring devices, home electronics, media players, receiving devices, set-top boxes, other computing devices, and IoT devices, etc. The client device 102 may be operated by a user and communicate with other devices connected to the network 110 and/or base station 112. The client device 102 may be a long-term evolution (LTE) component, 4^{th} generation (4G), 5^{th} generation (5G), new radio (NR) 5G component, 6th generation (6G), among others.

The client device 102 may include a hardware processor, memory, and/or circuitry (not explicitly shown) configured to perform any of the functions or actions of the client device 102 described herein. For example, a software application designed using software code may be stored in the memory and executed by the processor to perform the functions of the client device 102. The client device 102 is configured to communicate with other devices and components of the system 100 via the base station 112 (e.g., client Network function 140, etc.). A user may use the client device 102 to access the internet, for example, via the network 110.

A client device 102 may be served by a serving cell that covers a region in which the client device 102 is located. The client device 102 may be located in a network slice 106. A network slice 106 may refer to a specific, predefined segment of a network that is configured to meet specific network service requirements (e.g., service level agreement (SLA)) for client devices 102 that are connected to it.

In a multi-tenant environment, tenant 108 may refer to an organization, a department in an organization, and the like. Each tenant 108 may be associated with one or more client devices 102, which may be used by users associated with tenant 10 that use the network service provider associated with the tenant 108 to connect to network 110. In some cases, a tenant 108 may be serviced by one or more network slices 106. Additionally, in some cases, two or more tenants 108 may share one or more network slices 106. In the illustrated example, the tenant 108a may be associated with client devices 102a-b, tenant 108b may be associated with client devices 102c-d, and tenant 108c may be associated with client devices 102e-f. Each of tenants 108a, 108b, 108c may be an instance of a tenant 108. Similarly, each of client devices 102a, 102b, 102c, 102d, 102e, and 102f may be an instance of a client device 102. In some embodiments, one or more of the tenants 108a-d may be serviced by one or more network slices 106.

### Example Network

Network 110, in general, may be a wide area network (WAN), a personal area network (PAN), a cellular network, or any other technology that allows devices to communicate electronically with other devices. In one or more embodiments, the network 110 may include the Internet. The network 110 may include any suitable type of wireless and/or wired network. The network 110 may be a combination of one or more public and/or private networks, including a local area network (LAN), a metropolitan area network (MAN), a WAN, and the like.

### Example Base Station

Base station 112 may be a network node, an access point, an NB, an eNB, eNodeB, gNB or other types of wireless access points, and is generally configured to enable wireless communication between the client device 102 and other components of the system 100. The base station 112 may serve communication to devices within a serving cell that defines a corresponding coverage area of the serving cell. The base station 112 may be a serving base station for client device(s) 102, user devices, UEs, and mobile devices, collectively referred to herein as client devices 102. When a client device 102 is within a coverage area associated with a particular base station 112, the base station 112 provides communication coverage to the client device 102. For example, when the client device 102 comes into the cell associated with the base station 112, the client device 102 may communicate with the base station 112 by transmitting an uplink (UL) to the base station 112 and receiving a downlink (DL) from the base station 112. As the client device 102 travels between cells the base stations 112 performs the handover procedure to hand over facilitating the communication of the client device 102 with other devices.

In certain embodiments, the base station 112 may be configured to facilitate cellular networks, 4G, 5G, NR 5G Advanced, 6G, other 3GPP wireless technologies, and other wireless protocols. In certain embodiments, the base station 112 may also include a transceiver 114, a transmission filter 115, a receiving filter 116, memory 117 including memory resources, and processing resources including a processor 118 to facilitate operations of the base station 112, such as to transmit and receive mobile communication signals, and/or any other signals. For example, the transceiver 114 may include processing circuitry configured to transmit signals (e.g., mobile communication signals) to client devices 102, other base stations 112, and other communication systems to enable mobile communication and access to the network 110. The transmission filter 115 includes a bandpass filter with a strict passband. The passband corresponds to the bandwidth that is assigned for the base station 112. Any signals with frequencies outside the passband are filtered so that they are not transmitted from the base station 112. The receiving filter 116 includes a bandpass filter configured to ensure that the base station 112 will reject any signals outside of its designated bandwidth. Accordingly, the receiving filter 116 is a bandpass filter with a strict bandpass corresponding to the assigned bandwidth of the base station 112. The memory resources 117 include one or more computer-readable media that store software instructions for establishing a mobile communication network with the base station 112. The processing resources may include one or more processors 118, and processing circuitries configured to execute the software instructions 119 stored in the one or more computer-readable media of the memory resources 117 to perform wireless communication functions of the base station 112.

### Server Network Function

The server network function (NF) 120 may be a computing device and is generally configured to manage and coordinate various network services and operations, such as processing policy request messages 122, providing network requests, providing data routing, and providing network policies, among others. The server network function 120 may be formed by one or more physical computing devices configured to provide services and resources (e.g., data and/or hardware resources) for the components of the system 100. In some embodiments, the server network function 120 may include a server, a workstation, a virtual machine, etc. In some embodiments, the server network function 120 may be implemented by one or more computing devices in a distributed network. In one example, the server network function 120 may be a policy control function (PCF) in the 5G network 110. The PCF may be a producer of a service, but not the only producer in a 5G or 6G network. The PCF may enable network slicing, UE activities, network behavior control, and communication with other 5G core network functions. It also provides policy rules for control plane functions, such as roaming, mobility management, and network slicing. The PCF may access subscription information to make network policy decisions. In other examples, the server network function 120 may include other components of the 5G core network.

The server network function 120 may include a hardware processor, memory, and/or circuitry (not explicitly shown) configured to perform any of the functions or actions of the server network function 120 described herein. For example, a software application designed using software code may be stored in the memory and executed by the processor to perform the functions of the server network function 120.

The server network function 120 may receive a policy request message 122 from the client network function 140. The policy request message 122 may include a slice ID 152a, tenant ID 154a, and a device ID associated with the client device 102a from which the client network function 140 has received a non-access stratum (NAS) protocol request message 124. The policy request message 122 may include a requested policy for the client device 102a's network communication needs. The requested policy may include a set of rules that indicate how network resources are to be managed and allocated for the client device 102a. In some examples, the policies may include rules that indicate how network resources are managed and allocated among client devices 102, users, and applications.

In response, the server network function 120 may evaluate the content of the policy request message 122 and determine whether the requested policy aligns with the current network configuration and policies for the specified slice ID 152a, tenant ID 154a, and device ID. Based on the evaluation, the server network function 120 may update or modify the requested policy or leave it unchanged. In some cases, the server network function 120 may transmit a specific HTTP/2 status code 104 that indicates the outcome of the policy evaluation process. For example, the HTTP/2 status code 104 may indicate the request received, continuing processing (in case where the HTTP/2 status code 104 is 1xx), among other types of HTTP/2 status codes 104 described herein.

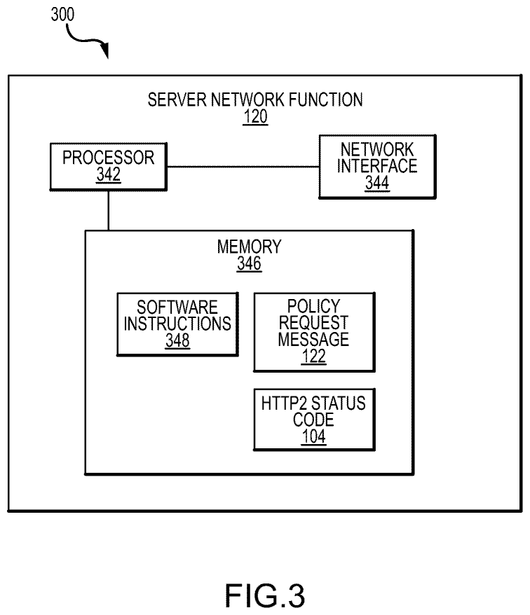

In cases where the server network function 120 detects a configuration or policy compliance issue with respect to the specific combination of slice ID 152 (optional), tenant ID 154, and a device ID associated with the client device 102, and/or with respect to the server network function 120 itself, it may communicate an HTTP/2 status error code 104 to the client network function 140. An example configuration of the server network function 120 is described in FIG. 3.

### Client Network Function

The client network function 140 may be a computing device and is generally configured to manage and coordinate the network communications and data processing needs of connected client devices 102. In some embodiments, the client network function 140 may include a server, a workstation, a virtual machine, etc. In a 5G network, the client network function 140 may be an access and mobility management function (AMF). In some embodiments, the client network function 140 may be implemented by one or more computing devices in a distributed network. The client network function 140 may be configured to handle network requests (e.g., NAS protocol request messages 124) for network access, data transmission, and receiving and interpreting responses from the server network function 120, among others. The client network function 140 may further be configured to implement a network policy provided by the server network function 120.

In case where an HTTP/2 status code 104 (e.g., error code) is received from the client network function 120, the client network function 140 may determine a type of the received HTTP/2 status code 104a and determine one or more mitigation actions 156a associated with the determined type of the received HTTP/2 status code 104a. In response, the client network function 140 may execute the one or more mitigation actions 156a to address and mitigate the HTTP/2 status code 104a. This process is described in greater detail further below.

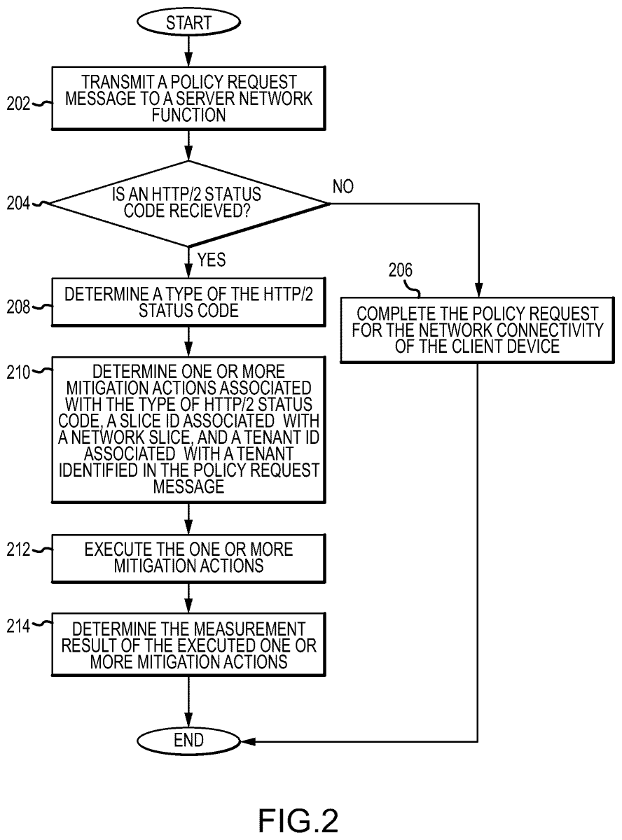

The client network function 140 comprises a processor 142 operably coupled with a network interface 144 and a memory 146. Processor 142 may include one or more specialized and/or general-purpose processors configured to perform one or more operations of the client network function 140 described herein. For example, the processor may be implemented by a special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. It should be understood that the functions performed by various components of FIG. 1 may be performed using one or more processors. As such, for example, functions of the client network function 140 may be performed by the processor 142 executing the software instructions 148. The processor 142 is configured to operate as described in FIGS. 1-2. For example, the processor 142 may be configured to perform one or more operations of the operational flow described in FIG. 1 and one or more operations of the method 200 as described in FIG. 2, or any other operation described herein.

Network interface 144 is configured to enable wired and/or wireless communications. The network interface 144 communicatively couples the client network function 140 to other devices, such as some or all of the components of the system 100. The network interface 144 may communicate over any type of network topology and communication link.

The network interface 144 may be any suitable hardware or software (e.g., executed by hardware) to facilitate any suitable type of communication in wireless or wired connections. These connections may comprise, but not be limited to, all or a portion of network connections coupled to additional network components in the network 110, client devices 102, an Intranet, a private network, a public network, a cellular network. The network interface 144 may be configured to support any suitable type of communication protocol.

The network interface 144 is configured to transmit and receive data from and to other devices, for example, the network interface 144 may include a 5G modem, a 5G interface, a NR 5G modem, a NR 5G interface, a 6G interface, and any other suitable type of communication protocol.

The memory 146 may include a non-transitory computer-readable medium having stored thereon instructions which may be used to program a computer (or other electronic devices) to perform a process. The non-transitory computer-readable medium may include but is not limited to, floppy diskettes, optical disks, compact disc read-only memories (CDROMs), magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions and data. The memory 146 may store any of the information described in FIGS. 1-2 along with any other data, instructions, logic, rules, or code operable to implement the function(s) described herein when executed by processor 142. For example, the memory 146 may store software instructions 148, mapping table 150, policy request message 122, HTTP/2 status code 104, results 160, and/or any other data and instructions described herein. The software instructions 148 may comprise any suitable set of instructions, logic, rules, or code operable to execute the operations of processor 142 and perform the functions described herein, such as some or all of those described in FIGS. 1-2.

The mapping table 150 may include an entry for each combination of slice ID 152 (optional), tenant ID 154, and HTTP/2 status code 104, associated with one or more mitigation actions 156 and a measurement protocol 158. For example, a first entry (row) of the mapping table 150 may include a first combination of slice ID 152a, tenant ID 154a, and HTTP/2 status code 104a, associated with the first mitigation action(s) 156a and measurement protocol 158a, and a second entry (row) may include a second combination of slice ID 152b, tenant ID 154b, and HTTP/2 status code such as status error code 104b, associated with the second mitigation action(s) 156b and measurement protocol 158b. Each slice ID 152 may be a single network slice selection assistance information identifier (S-NSSAI-ID). The S-NSSAI-ID may include a slice/service type (SST) and a slice differentiator (SD). The SST may be specific based on the specific type of service (e.g., enhanced mobile broadband (eMBB), ultra-reliable low-latency communications (URLLC), internet of things (IoT), vehicle-to-everything (V2X), etc.). In some embodiments, the client network function 140 may map the SD of the slice ID 152 to the respective tenant ID 154.

A mitigation action 156 associated with a specific slice ID 152, tenant ID 154, and HTTP/2 status code 104 (e.g., error code), may include certain actions that are configured to mitigate and address the issues identified by the respective HTTP/2 status code 104 (e.g., error code), and is customized for the specific slice ID 152 and tenant ID 154. The mitigation action 156 is customized for the specific slice ID 152 (identifying the associated network slice 106) and the tenant ID 154 to allow for a dynamic mitigation plan adapted to address specific network and operational needs of policy requirements of each slice 106 of the network. The dynamic customization of mitigation actions 156 allows for more effective and tailored network resource and communication management for a given slice ID 152 and tenant ID 154 because the actions 156 are configured to address unique challenges and requirements of the given slice ID 152 and tenant ID 154. The customized mitigation actions 156 may also be based on the type of the HTTP/2 status code 104 (e.g., error code), so that the actions 156 that are configured to address and mitigate the specific type of the HTTP/2 status code 104 (e.g., error code) are executed.

Furthermore, each mitigation action 156 is associated with a respective measurement protocol 158 which is configured to evaluate the outcome of the executed respective mitigation action 156. In response to a measurement protocol 158 being implemented, a result 160 of the executed mitigation action 156 may be provided, such as network response outcome depending on a given combination of slice ID 152, tenant ID 154, and HTTP/2 status code such as status error code 104.

### Operational Flow for Managing Network Conditions in a Multi-Tenant Environment

In operation, the operational flow of the system 100 may begin when a user using a client device 102 (e.g., client device 102a) initiates an event that requires network resources, such as browsing on the Internet, streaming media files, communicating with another client device 102, connecting to network 110, and the like. The client device 102a may be subscribed to a network service provided by a network provider associated with the tenant 108a. The tenant 108a may be an organization or a segment of an organization, for example. The tenant 108a may be uniquely identified by the tenant ID 154a. The tenant ID 154a may be a serial number, alphanumeric string, and the like. The tenant 108a may subscribe to network services to fulfill network requirements of client devices 102 that attempt to connect to the network 110 via the network provider.

When the client device 102a subscribes to the network service provider of the tenant 108a, the tenant 108a (and/or network service provider) may provide the slice ID 152a which is associated with the network slice 106 that serves the tenant 108a to the client device 102a. The slice ID 152a may be a serial number, alphanumeric string, and the like. This is to inform the client device 102a about the network slice 106 that servers the tenant 108a. In the example of FIG. 1, assume that the tenant 108a is serviced by the network slice 106. The network slice 106 may be assigned to the tenant 108a and possibly shared with other tenants 108b-c depending on the configuration.

The network slice 106 may be configured to provide network resources according to the SLA agreed upon by the tenant 108a to facilitate specific network service quality indicated in the SLA to be provided to the client devices 108a-b that connect to network 110 via the network service provider associated with the tenant 108a.

In response to the user using a client device 102a to initiate the event that requires network resources, the client device 102a may transmit a NAS protocol request message 124 to the client network function 140. The NAS protocol request message 124 may include the slice ID 152a, tenant ID 154a, a request for network resources, and a device ID associated with the client device 102a, among others to accommodate the network resources required by the event.

The client network function 140 may receive the NAS protocol request message 124. In response, the client network function 140 may transmit a policy request message 122 to the server network function 120, where the policy request message 122 may include the tenant ID 154a, slice ID 152a, and device ID associated with the client device 102a, among other information. The policy request message 122 may include a request for a network policy for the client device 102a's network communication needs per the SLA associated with the network slice 106. The policy request message 122 may indicate a request to provide an access management policy for a client device 102a associated with the tenant ID 154a and the network slice ID 152a.

### Evaluating the Policy Request Message

The server network function 120 may receive the policy request message 122 and determine whether to issue an HTTP/2 status code 104 or HTTP/2 status error code 104 depending on the current situations, including server load, server error, client error, network error, the validity of the message 122 depending on syntax in the message 122, among others. In some embodiments, in response to determining that the server network function 120 is able to understand, accept, and accommodate the policy request message 122, the server network function 120 may transmit an HTTP/2 status code 104a, such as 2xx code to the client network function 140, where the HTTP/2 status code 104a indicates that the request was successfully received, understood, and accepted. In response, the client network function 140 may implement the requested network policy (e.g., allocating network resources, setting, or modifying network communication quality parameters, etc.) for the client device 102a to meet the client device 102's network resource and communication needs according to the SLA.

In some embodiments, in response to determining that there is an issue with respect to the configuration, policy compliance with respect to the specific combination of slice ID 152a, tenant ID 154a, and a device ID associated with the client device 102a, server-side error, client-side error, network-side error, and/or with respect to the server network function 120 itself, the server network function 120 may issue and transmit an appropriate HTTP/2 status error code 104a (e.g., 4xx, or 5xx) to the client network function 140. Further, in some examples, if further action is required to complete the request due to redirection needs, a 3xx HTTP/2 status code 104a may be transmitted.

Depending on a given situation, the server network function 120 may issue and transmit a specific HTTP/2 status error code 104a. For example, if it is determined that further action is needed to be taken in order to complete the policy request in the policy request message 122, the server network function 120 may issue and transmit a 3xx HTTP/2 status error code 104a (such as 301, 302, etc.). In another example, if it is determined that the policy request message 122 contains bad syntax or cannot be accommodated, the server network function 120 may issue and transmit a 4xx HTTP/2 status error code 104a (such as 401, 402, 403, etc.). In another example, if it is determined that the server (server network function 120) has failed to accommodate an apparently valid policy request message 122, the server network function 120 may issue and transmit a 5xx HTTP/2 status error code 104a (such as 501, 502, 503, etc.). The xx in 1xx, 2xx, 3xx, 4xx, and 5xx may be any number as defined in the HTTP/2 status code standard.

The client network function 140 may receive the HTTP/2 status code 104a from the server network function 120. The HTTP/2 status code 104a may be in response to the specific network request (included in the NAS protocol request message 124) originated from the client device 102a. The network request may include loading a website, streaming a media file, allocating network resources for an online task, and the like.

### Determining Action(s) to Address the HTTP/2 Status Code

In response to receiving the HTTP/2 status code, such as status error code 104a, the client network function 140 may determine the type of the HTTP/2 status code such as status error code 104. The type of the HTTP/2 status code, such as status error code 104a may be indicated by the specific number of the error code 104a, e.g., 301, 404, 504, etc. The type of the HTTP/2 status code, such as status error code 104a may indicate whether the HTTP/2 status code, such as status error code 104a is related to a client-side error, a server-side error, or a network-side error depending on a current situation of the network devices (e.g., client network function 140, server network function 120, client device 102a, etc.) and network traffic among the network devices, similar to that described herein.

In response to determining the type of the HTTP/2 status code 104a, the client network function 140 may determine one or more mitigation actions 156a that are associated with the determined type of the HTTP/2 status code 104a, and the specific combination of slice ID 152a (optional), tenant ID 154a, and HTTP/2 status code 104a. In this process, the client network function 140 may search within the mapping table 150 to identify a row (entry) that indicates the specific combination of the slice ID 152a (optional), tenant ID 154a, and the HTTP/2 status code 104a. The client network function 140 may evaluate each entry until it identifies the entry with the specific combination in the current situation. In the example of FIG. 1, the client network function 140 may identify that the first row (entry) indicates the specific combination of the slice ID 152a (optional), tenant ID 154a, and the HTTP/2 status code 104a. In response, the client network function 140 may determine the one or more mitigation actions 156a that are indicated in the first entry of the mapping table 150. Further in response, the client network function 140 may execute the one or more mitigation actions 156a. In implementations where the slice ID 152a is mapped to the tenant ID 154, using the slice ID 152a in the combination may be optional.

The one or more mitigation actions 156a may be customized based on the slice ID 152a, tenant ID 154a, and HTTP/2 status code 104a. The one or more mitigation actions 156a may be further customized based on a priority level associated with the slice ID 152a. For example, the client network function 140 may prioritize the mitigation actions 156a if the priority level associated with the slice ID 152a is more than the priority levels associated with other network slices, e.g., on a scale of 1 to 10 priority levels.

In some embodiments, the mitigation actions 156a may include redirecting the policy request message 122 to a second server network function. For example, if the HTTP/2 status error code 104a is a 3xx code that indicates further action needs to be taken in order to accommodate the policy request, the slice ID 152a is associated with the network slice 106 that is associated with a high-priority level (more than priority levels of other network slices, e.g., more than a threshold (more than 7 out of 10)) and certain QoS requirement, the tenant ID 154a is associated with a tenant 108a that is known to require high-speed network connectivity, the client network function 140 may redirect the policy request message 122 to a second server network function, and additionally, prioritize the mitigation action 156a over other network requests with respect to other network slices with lower priority levels.

In the same or another example, assume that the client network function 140 receives an HTTP/2 status code 104a as 307 (Temporary Redirect) from the server network function 120, indicating that the requested resource is temporarily available at a different uniform resource identifier (URI). This redirection may occur due to maintenance, server load balancing, or other temporary server-side issues.

Upon receiving the 307 error code, the client network function 140 may search the mapping table 150 to determine the appropriate mitigation action 156a based on the specific combination of slice ID 152a (optional), tenant ID 154a, and HTTP/2 status code 104a. The entry found in the mapping table 150 may include a mitigation action 156a indicates that in the event of a 307 code status, the policy request message 122 should be redirected to an alternative server network function. In response, the client network function 140 may dynamically update the destination of the policy request message 122 to point to the second server network function, as indicated by the new URI provided in the error message.

In some embodiments, mitigation actions 156a may include allocating a certain amount of network resources to the policy request message 122. In an example, assume that the policy request message 122 is allocated with the first amount of network resources, and an HTTP/2 status code 104a is issued due to network congestion, indicating a 503 (Service Unavailable). In response, the client network function 140 determines that the error stems from insufficient network capacity at the moment the policy request message 122 was being processed.

Upon identifying the combination of slice ID 152a (optional), tenant ID 154a, and HTTP/2 status code 104a corresponding to the 503 error code, the client network function 140 searches the mapping table 150 to find the appropriate mitigation action 156a. The entry identified specifies that in case of a 503 error code for slice ID 152a, tenant ID 154a, the policy request message 122 should be allocated additional network resources (mitigation action 156a). Following this prescribed action, the client network function 140 may allocate (e.g., physically allocate) a second amount of network resources to the policy request message 122, where the second amount is higher than the first amount of network resources previously allocated to the policy request message 122.

In some embodiments, the mitigation actions 156a may include waiting at least a threshold time period before re-transmitting the policy request message 122 to the server network function 120. In an example, assume that the client network function 140 initially received an HTTP/2 status code 104a as 408 (Request Timeout) from the server network function 120. This error indicates that the server did not receive a complete request from the client within the allotted time, potentially due to high network traffic or server load. In response to this error, the client network function 140 may search within the mapping table 150 to determine the appropriate action 156a based on the combination of slice ID 152a (optional), tenant ID 154a, and HTTP/2 status code 104a. The table entry for this particular example may direct the client network function 140 to implement a delay mechanism. For example, the client network function 140 may execute the mitigation action 156a by waiting a predetermined threshold time period, calculated based on current network conditions and historical data specific to the network slice 106 and tenant 108a involved. In this way, the waiting period may allow the network congestion or server load to decrease before retransmitting the policy request message 122 to the server network function 120. After the threshold time period has elapsed, the client network function 140 may re-transmit the policy request message 122 to the server network function 120. This helps to avoid further request timeouts and improves the overall efficiency of the network communication by aligning the retry with a more timely network state.

In some embodiments, the mitigation actions 156a may include adjusting a security protocol associated with the policy request message 122 based on the type of the HTTP/2 status code 104a, where adjusting the security protocol includes updating an encryption protocol associated with the policy request message 122. In an example, assume that the client network function 140 receives an HTTP/2 status code 104 as 403 (Forbidden), which may indicate a security or authorization issue with the policy request message 122. This may arise due to outdated encryption standards or security credentials that no longer meet the server network function 120's requirements.

In response to receiving this particular error code, the client network function 140 may search the mapping table 150 to identify the mitigation action 156a based on the specific combination of slice ID 152a (optional), tenant ID 154a, and HTTP/2 status code 104a. The corresponding entry in the mapping table 150 may include a mitigation action 156a that indicates that security protocols, such as the encryption standards, should be adjusted to comply with the latest security requirements set by the server network function 120 and/or the SLA. In response, the client network function 140 may update the encryption protocol associated with the policy request message 122. For example, the client network function 140 may implement a more secure version of TLS that meets the current security standards. The client network function 140 may retransmit the policy request message 122 with the updated security protocol to the server network function 120. In this way, the 403 error code may be addressed and mitigated dynamically by the client network function 140.

In some embodiments, the mitigation actions 156a may be customized and tailored for each specific combination of slice ID 152a (optional), tenant ID 154a, and HTTP/2 status code 104a. The slice 106 may provide certain network requirements such as latency, throughput, and data priority, and serve different types of applications, such as from low-latency applications to high-bandwidth video streaming services. As such, the mitigation actions 156a may be tailored to preserve the intended network service quality of the slice 106 identified by the slice ID 152a. The tenant ID 154a identifies the tenant 108a that is involved policy request. The tenant 108a may have certain QoS expectations per the SLA with the slice 106. Thus, the mitigation actions 156a may be configured to provide the expected QoS.

In some embodiments, the mitigation actions 156a may be time specific. For example, various mitigation actions 156a may be associated with a respective time period. For example, if the HTTP/2 status code 104a is received during off-peak hours, the mitigation action 156a for during off-peak hours may include actions that do not require immediate operations, such as updating, implementing a longer delay, etc.

In response to the mitigation action(s) 156a being executed, the client network function 140 may determine a result 160 of the executed mitigation action(s) 156a. The result 160 may be represented by network communications in response to the mitigation action(s) 156a. The client network function 140 may determine the result 160 of the executed mitigation action(s) 156a by monitoring the network communications between the network devices involved. In this process, the client network function 140 may execute the measurement protocol 158a that is configured to determine the result 160 of the mitigation action(s) 156a. For example, in the case of redirecting the policy request message 122 due to a 307 (Temporary Redirect) error code, the measurement protocol 158a may include operations to determine whether the indication operation is executed. The result of the mitigation action(s) 156a may include the indication of whether the redirection of the policy request message 122 resulted in processing and completing the policy request.

In another example, in the case of redirecting the policy request message 122 due to a 503 (Service Unavailable) error code, the measurement protocol 158a may include operations to determine whether the network resource allocation to the policy request message 122 is executed. The result of the mitigation action(s) 156a may include the indication of whether the network resource allocation to the policy request message 122 resulted in processing and completing the policy request.

In another example, in the case of retransmitting the policy request message 122 after a threshold delay period due to a 408 (Request Timeout) error code, the measurement protocol 158a may include operations to determine whether the retransmission of the policy request message 122 after the threshold delay is executed. The result of the mitigation action(s) 156a may include the indication of whether the retransmission of the policy request message 122 after the threshold delay resulted in processing and completing the policy request.

In another example, in the case of retransmitting the policy request message 122 after a threshold delay period due to 403 (Forbidden) error operations, the measurement protocol 158a may include operations to determine whether updating the security protocol of the policy request message 122 is executed. The result of the mitigation action(s) 156a may include the indication that whether updating the security protocol of the policy request message 122 is executed resulted in processing and completing the policy request.

Thus, the measurement protocol 158 and result 160 of the measurement may vary for each specific situation and combination of slice ID 152a (optional), tenant ID 154a, and HTTP/2 status code 104a. The client network function 140 may output/report the result 160, for example, display the result 160 on a display screen of the client network function 140. A network administrator may review the results and provide feedback to the client network function 140. In some embodiments, the mapping table 150, more specifically, the mitigation actions 156 and measurement protocol 158, may be updated based on the feedback. In some embodiments, additional entries may be added to the mapping table 150 as new situations of slice IDs 152, tenant IDs 154, and HTTP/2 status codes 104 are encountered.

The examples and embodiments described in the present disclosure are non-limiting and are not meant to limit the scope of the present disclosure. For brevity, certain examples and embodiments for certain HTTP/2 codes are described with certain mitigation actions and measurement protocols. However, the present disclosure also contemplates mitigation actions and measurement protocols for other HTTP/2 status codes. In light of the present disclosure, one of ordinary skill in the art would recognize that the principles described herein may be adapted and applied to a wide range of other HTTP/2 status codes beyond those explicitly disclosed. Additionally, the mitigation actions and measurement protocols may be tailored to address unique network circumstances, performance requirements, and tenant network connectivity needs as they arise.

### Method for Managing Network Conditions in a Multi-Tenant Environment

FIG. 2 illustrates an example flowchart of a method 200 for managing network conditions in a multi-tenant environment, according to some embodiments of the present disclosure. Modifications, additions, or omissions may be made to method 200. Method 200 may include more, fewer, or other operations. For example, operations may be performed in parallel or in any suitable order. While at times discussed as the system 100, client network function 140, or components of any of thereof performing operations, any suitable system or components of the system may perform one or more operations of the method 200. For example, one or more operations of method 200 may be implemented, at least in part, in the form of software instructions (e.g., software instructions 148 of FIG. 1), stored on tangible non-transitory computer-readable media (e.g., memory 146 of FIG. 1) that when run by one or more processors (e.g., processor 142 of FIG. 1) may cause the one or more processors to perform operations 202-214.

At operation 202, the client network function 140 may transmit a policy request message 122 to a server network function 120. For example, the client network function 140 may transmit the policy request message 122 in response to the NAS protocol message 124 received from the client device 102a, similar to that described in FIG. 1.

At operation 204, the client network function 140 may determine whether an HTTP/2 status code 104 is received. If the server network function 120 issues and transmits an HTTP/2 status code 104 to the client network function 140, the client network function 140 may determine that the HTTP/2 status code 104 is received. If it is determined that the HTTP/2 status error code 104 is received, the method 200 may proceed to operation 208. Otherwise, if an HTTP/2 status code (that does not include an error) is received, the method 200 may proceed to operation 206. At operation 206, the client network function 140 may complete the policy request for the network connectivity of the client device 102a, similar to that described in FIG. 1.

At operation 208, the client network function 140 may determine a type of HTTP/2 status code 104. For example, the client network function 140 may parse the received code and determine its code number, similar to that described in FIG. 1.

At operation 210, the client network function 140 may determine one or more mitigation actions 156a associated with the type of the HTTP/2 status code 104a, a slice ID 152a associated with the slice 106, and a tenant ID 154a associated with the tenant 108a identified in the policy request message 122, similar to that described in FIG. 1.

At operation 212, the client network function 140 may execute the one or more mitigation actions 156a. At operation 214, the client network function 140 may determine the measurement results 160 of the executed one or more mitigation actions 156a. In response, the client network function 140 may output the results 160, similar to that described in FIG. 1.

### Server Network Function

FIG. 3 illustrates an example configuration 300 of the server network function 120. The server network function 120 comprises a processor 342 operably coupled with a network interface 344 and a memory 346. Processor 342 may include one or more specialized and/or general-purpose processors configured to perform one or more operations of the server network function 120 described herein. For example, the processor may be implemented by a special-purpose hardware (e.g., circuitry), as programmable circuitry appropriately programmed with software and/or firmware, or as a combination of special-purpose and programmable circuitry. Hence, embodiments may include a machine-readable medium having stored thereon instructions that may be used to program a computer (or other electronic devices) to perform a process. It should be understood that the functions performed by various components of FIG. 1 may be performed using one or more processors. As such, for example, functions of the server network function 120 may be performed by the processor 342 executing the software instructions 348. The processor 342 is configured to operate as described in FIGS. 1-2. For example, the processor 342 may be configured to perform one or more operations of the operational flow described in FIG. 1 and one or more operations of the method 200 as described in FIG. 2, or any other operation described herein.

Network interface 344 is configured to enable wired and/or wireless communications. The network interface 344 communicatively couples the server network function 120 to other devices, such as some or all of the components of the system 100 (see FIG. 1). The network interface 344 may communicate over any type of network topology and communication link.

The network interface 344 may comprise one or more antennas as part of a transceiver, a receiver, or a transmitter for communicating using one or more wireless communication protocols or technologies. In some embodiments, the network interface 344 may be configured to communicate using, for example, NR and/or LTE using at least some shared radio components. In some embodiments, the network interface 344 may be configured to communicate using single or shared RF bands. The RF bands may be coupled to a single antenna or may be coupled to multiple antennas (e.g., for a MIMO configuration) to perform wireless communications. The network interface 344 may be configured to comprise one or more peripherals such as a network interface, one or more administrator interfaces, and one or more displays.

The network interface 344 may be any suitable hardware or software (e.g., executed by hardware) to facilitate any suitable type of communication in wireless or wired connections. These connections may comprise, but not be limited to, all or a portion of network connections coupled to additional network components in the network 110, client devices 102, the Internet, an Intranet, a private network, a public network, a peer-to-peer network, the public switched telephone network, a cellular network, a LAN, a MAN, a WAN, and a satellite network. The network interface 344 may be configured to support any suitable type of communication protocol.

The network interface 344 is configured to transmit and receive data from and to other devices, for example, the network interface 344 may include a WiFi modem, a WiFi interface, a 5G modem, a 5G interface, a NR 5G modem, a NR 5G interface, a 4G modem, a 4G interface, a 6G modem, a 6G interface, a LTE modem, a LTE interface, a LAN modem, a LAN interface, a MAN modem, a MAN interface, a WAN modem, WAN interface, and any other suitable type of communication protocol.

The memory 346 may include a non-transitory computer-readable medium having stored thereon instructions which may be used to program a computer (or other electronic devices) to perform a process. The non-transitory computer-readable medium may include but is not limited to, floppy diskettes, optical disks, CDROMs, magneto-optical disks, ROMs, RAMs, EPROMs, EEPROMs, magnetic or optical cards, flash memory, or other type of media/machine-readable medium suitable for storing electronic instructions and data. The memory 346 may store any of the information described in FIGS. 1-2 along with any other data, instructions, logic, rules, or code operable to implement the function(s) described herein when executed by processor 342. For example, the memory 346 may store software instructions 348, mapping table 150, policy request message 122, HTTP/2 status code 104, and/or any other data and instructions described herein. The software instructions 348 may comprise any suitable set of instructions, logic, rules, or code operable to execute the operations of processor 342 and perform the functions described herein, such as some or all of those described in FIGS. 1-2.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated with another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S. C. § 112(f) as it exists on the date of filing hereof unless the words “means for” or “step for” are explicitly used in the particular claim.

1. A system for managing network responses to error conditions in a multi-tenant environment, comprising:
a memory configured to store one or more mitigation actions associated with a hypertext transfer protocol version 2 (HTTP/2) status code; and
a processor, operably coupled with the memory, and configured to:
transmit a policy request message to a server network function, wherein:
the policy request message comprises at least a tenant identifier (ID); and
the policy request message indicates to provide an access management policy for a client device associated with the tenant ID;
receive, from the server network function, the HTTP/2 status code, wherein the HTTP/2 status code is in response to a specific network request originated from the client device;
determine a type of the HTTP/2 status code, wherein the type of the HTTP/2 status code indicates whether the HTTP/2 status code is related to a client-side error, a server-side error, or a network-side error;
in response to determining the type of the HTTP/2 status code, execute the one or more mitigation actions associated with the HTTP/2 status code, wherein the one or more mitigation actions are customized based at least in part upon at least one of the tenant ID or the type of the HTTP/2 status code;
determine a result of the one or more mitigation actions, wherein the result is represented by a network communication in response to the executed one or more mitigation actions; and
report the result.

2. The system of claim 1, wherein the HTTP/2 status code is an HTTP/2 status error code.

3. The system of claim 1, wherein the one or more mitigation actions comprise redirecting the policy request message to a second server network function.

4. The system of claim 1, wherein the one or more mitigation actions comprise waiting at least a threshold time period before re-transmitting the policy request message to the server network function.

5. The system of claim 1, wherein:
the policy request message is allocated with a first amount of network resources;
the one or more mitigation actions comprise allocating a second amount of network resources to the policy request message; and
the second amount of network resources is more than the first amount of network resources.

6. The system of claim 1, wherein the one or more mitigation actions comprise adjusting a security protocol associated with the policy request message based at least in part upon a type of the HTTP/2 status code, wherein adjusting the security protocol comprises updating an encryption protocol associated with the policy request message.

7. The system of claim 1, wherein the one or more mitigation actions are further customized based at least in part upon a priority level associated with a network slice ID associated with the client device.

8. A method for managing network responses to error conditions in a multi-tenant environment, comprising:
transmitting a policy request message to a server network function, wherein:
the policy request message comprises at least a tenant identifier (ID); and
the policy request message indicates to provide an access management policy for a client device associated with the tenant ID;
receiving, from the server network function, a hypertext transfer protocol version 2 (HTTP/2) status code, wherein the HTTP/2 status code is in response to a specific network request originated from the client device;
determining a type of the HTTP/2 status code, wherein the type of the HTTP/2 status code indicates whether the HTTP/2 status code is related to a client-side error, a server-side error, or a network-side error;
in response to determining the type of the HTTP/2 status code, executing one or more mitigation actions associated with the HTTP/2 status error code, wherein the one or more mitigation actions are customized based at least in part upon at least one of the tenant ID, or the type of the HTTP/2 status error code;
determining a result of the one or more mitigation actions, wherein the result is represented by a network communication in response to the executed one or more mitigation actions; and
reporting the result.

9. The method of claim 8, wherein the tenant ID is mapped to a network slice ID associated with the client device.

10. The method of claim 8, wherein the one or more mitigation actions comprise redirecting the policy request message to a second server network function.

11. The method of claim 8, wherein the one or more mitigation actions comprise waiting at least a threshold time period before re-transmitting the policy request message to the server network function.

12. The method of claim 8, wherein:
the policy request message is allocated with a first amount of network resources;
the one or more mitigation actions comprise allocating a second amount of network resources to the policy request message; and
the second amount of network resources is more than the first amount of network resources.

13. The method of claim 8, wherein the one or more mitigation actions comprise adjusting a security protocol associated with the policy request message based at least in part upon a type of the HTTP/2 status code, wherein adjusting the security protocol comprises updating an encryption protocol associated with the policy request message.

14. The method of claim 8, wherein the one or more mitigation actions are further customized based at least in part upon a priority level associated with a network slice ID associated with the client device.

15. A non-transitory computer-readable medium storing instructions that when executed by one or more processors, cause the one or more processors to:
transmit a policy request message to a server network function, wherein:
the policy request message comprises at least a tenant identifier (ID); and
the policy request message indicates to provide an access management policy for a client device associated with the tenant ID;
receive, from the server network function, a hypertext transfer protocol version 2 (HTTP/2) status code, wherein the HTTP/2 status code is in response to a specific network request originated from the client device;
determine a type of the HTTP/2 status code, wherein the type of the HTTP/2 status code indicates whether the HTTP/2 status code is related to a client-side error, a server-side error, or a network-side error;
in response to determining the type of the HTTP/2 status code, execute one or more mitigation actions associated with the HTTP/2 status code, wherein the one or more mitigation actions are customized based at least in part upon at least one of the tenant ID, or the type of the HTTP/2 status error code;
determine a result of the one or more mitigation actions, wherein the result is represented by a network communication in response to the executed one or more mitigation actions; and
report the result.

16. The non-transitory computer-readable medium of claim 15, wherein transmitting the policy request message is in response to receiving a non-access stratum (NAS) protocol request message from the client device, wherein the NAS protocol request message comprises the tenant ID associated with the client device.

17. The non-transitory computer-readable medium of claim 15, wherein the one or more mitigation actions comprise redirecting the policy request message to a second server network function.

18. The non-transitory computer-readable medium of claim 15, wherein the one or more mitigation actions comprise waiting at least a threshold time period before re-transmitting the policy request message to the server network function.

19. The non-transitory computer-readable medium of claim 15, wherein:
the policy request message is allocated with a first amount of network resources;
the one or more mitigation actions comprise allocating a second amount of network resources to the policy request message; and
the second amount of network resources is more than the first amount of network resources.

20. The non-transitory computer-readable medium of claim 15, wherein the one or more mitigation actions comprise adjusting a security protocol associated with the policy request message based at least in part upon a type of the HTTP/2 status code, wherein adjusting the security protocol comprises updating an encryption protocol associated with the policy request message.
